(19) United States
(12) Patent Application Publication
(10) Pub. No.: US 2015/0066619 A1
(43) Pub. Date: Mar. 5, 2015

(54) SYSTEMS AND METHODS FOR PROVIDING POTENTIAL DISCOUNTS TO CUSTOMERS

(71) Applicant: Gary Swenson, Mahwah, NJ (US)

(72) Inventor: Gary Swenson, Mahwah, NJ (US)

(21) Appl. No.: 14/099,135

(22) Filed: Dec. 6, 2013

Related U.S. Application Data
(60) Provisional application No. 61/872,062, filed on Aug. 30, 2013.

(51) Int. Cl. G06Q 30/02

(52) U.S. Cl. CPC G06Q 30/0222
USPC 705/14.23

(57) ABSTRACT

A system and method for providing a discount to a customer are disclosed. The system and method include receiving at the processor from a merchant a selection of a particular opportunity for a discount from a plurality of opportunities for a discount; determining by the processor a plurality of discount prices and a number of product for discount at each of the plurality of discount prices based on the opportunity received from the merchant, the quantity of products and the average yield price; receiving from a customer a request for a purchase of a product for processing through an electronic payment system; providing by the processor at the second terminal the opportunity for a discount to the customer; receiving by the processor through the second terminal an input from the customer based on the opportunity for a discount; crediting the customer with the discount through the electronic payment system.

### TECHNICAL FIELD

The present disclosure generally relates to devices, systems and methods for providing potential discounts to customers, and more particularly, to providing potential discounts to customers in an e-commerce environment.

### BACKGROUND

The use of coupons in consumer transactions is well known. These coupons are often issued by a manufacturer to entice a consumer to purchase a product made by the manufacturer. The coupon may be for an offer of discount at a point of sale and/or may be a rebate for an after-sale reimbursement.

Prior art rebate systems require a customer to purchase a product, locate a rebate certificate, fill out the rebate certificate, and then mail in a copy of the purchase receipt along with the rebate certificate. This process is a time consuming and tedious process, and often takes several weeks or months for the customer to receive the rebate. In addition, the rebate certificates are often placed at inconvenient locations requiring customers to search for them in remote areas of stores or online.

This disclosure describes improvements over these prior art technologies.

### SUMMARY

Accordingly, a system for providing potential discounts to customers is provided. The system includes a processor for receiving from a first terminal a request of a customer to purchase a product, providing through the first terminal the customer with an opportunity to receive a discount on the purchase of the product, receiving from the first terminal an input by the customer based on the opportunity provided, determining to provide either a discount or no discount based on the input and at least one discount criteria for the product, if a discount is provided, crediting the customer with the discount through an electronic payment system, and providing at the first terminal the results of the determination; and a memory for storing product information to enable the processor to process the purchases and provide the opportunity.

Accordingly, a method for providing discounts to customers is provided. The method includes receiving at a processor from a first terminal a request of a customer to purchase a product; providing by the processor through the first terminal the customer with an opportunity to receive a discount on the purchase of the product from among a plurality of discounts; receiving from the first terminal an input by the customer based on the opportunity provided; determining by the processor to provide either a discount or no discount based on the input and at least one discount criteria for the product; if a discount is provided, crediting the customer with the discount through an electronic payment system; and providing at the first terminal the results of the determination.

Accordingly, a system for providing discounts to customers is provided. The system includes a processor a processor for receiving from a first terminal an identity of a product for sale, a quantity of the product available for sale, a retail price for the product, and an average yield price for the quantity of the product, receiving from a merchant a selection of a particular opportunity for a discount from a plurality of opportunities for a discount, determining a plurality of discount prices and a number of product for discount at each of the plurality of discount prices based on the opportunity received from the merchant, the quantity of products and the average yield price, receiving from a second terminal a request from a customer to purchase a product, providing at the second terminal the opportunity for a discount to the customer, receiving through the second terminal an input from the customer based on the opportunity for a discount, crediting the customer with the discount through an electronic payment system, and providing at the second terminal the results of the determination of a discount; and a memory for storing product information to enable the processor to process the purchases and provide the opportunity.

Accordingly, a method for providing discounts to customers is provided. The method includes receiving at a processor from a first terminal an identity of a product for sale, a quantity of the product available for sale, a retail price for the product, and an average yield price for the quantity of the product; receiving at the processor a selection of a particular opportunity for a discount from a plurality of opportunities for a discount; determining by the processor a plurality of discount prices and a number of product for discount at each of the plurality of discount prices based on the opportunity received from the merchant, the quantity of products and the average yield price; receiving from a customer a request for a purchase of a product for processing through an electronic payment system; providing by the processor at the second terminal the opportunity for a discount to the customer; receiving by the processor through the second terminal an input from the customer based on the opportunity for a discount; crediting the customer with the discount through the electronic payment system; and providing at the second terminal the results of the determination of a discount.

### BRIEF DESCRIPTION OF THE DRAWINGS

The present disclosure will become more readily apparent from the specific description accompanied by the following drawings, in which:

FIG. 1 is a diagram illustrating a system for providing a customer with an opportunity for a discount according to the present disclosure;

FIG. 2 is a flowchart illustrating a method for providing a customer with an opportunity for a discount according to the present disclosure for the merchant side processing;

FIG. 3 is a flowchart illustrating a method for providing a customer with an opportunity for a discount according to the present disclosure for the customer side processing;

FIGS. 4A and 4B are flowcharts illustrating methods for providing a discount to a customer while maintaining an average yield price per product sold; and

FIG. 5 is a flowchart illustrating the process for determining the discounts to be made available to a customer.

Like reference numerals indicate similar parts throughout the figures.

### DETAILED DESCRIPTION

The present disclosure may be understood more readily by reference to the following detailed description of the disclosure taken in connection with the accompanying drawing figures, which form a part of this disclosure. It is to be understood that this disclosure is not limited to the specific devices, methods, conditions or parameters described and/or shown herein, and that the terminology used herein is for the purpose of describing particular embodiments by way of example only and is not intended to be limiting of the claimed disclosure.

Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

A system and method for providing a potential discount to a customer according to the present disclosure can present a customer with an opportunity to be awarded a discount on a product.

Reference will now be made in detail to the exemplary embodiments of the present disclosure, which are illustrated in the accompanying figures.

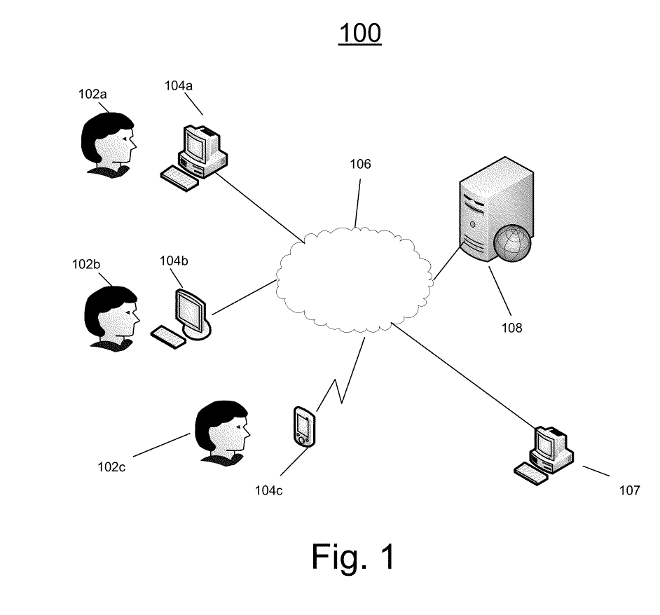

As shown in FIG. 1, a system for providing an opportunity for a discount 100 includes users or customers 102a-102c, computers or terminals 104a-104c, network (e.g. Internet) 106, merchant terminal or computer 107, and system computer 108. System computer 108 includes at least a processor (not shown) for providing overall control for system 108 and a memory (not shown) for storing data and programs.

System computer 108 provides an opportunity for a discount by receiving product information from a merchant, processing the product information to generate a plurality of discounts, receiving a purchase request from a customer, and providing an opportunity for one of the plurality of discounts. The opportunity for the discount is based, at least in part, on the purchase request, the generated discounts and a further input from the customer. In one embodiment the purchase is fully processed before the opportunity for a discount is provided; in another embodiment the opportunity for a discount is provided prior to a final purchase; further embodiments are contemplated.

In general operation, a merchant logs onto system computer 108 through merchant terminal 107. Although merchant terminal 107 can be a dedicated terminal, it is not required to be so; that is, merchant terminal 107 can be a personal computer, mobile device, etc. Each merchant has a unique merchant account set up on system computer 108 that identifies the merchant and its products available for sale via system 100. For example, the name, address, contact information, etc. of the merchant can be included in the merchant information and stored in the memory of system computer 108; other merchant information included in the merchant account is contemplated. A merchant interface or dashboard (not shown) can be provided by system computer 108 to a merchant at merchant terminal 107 for ease of entry, viewing and editing of the merchant information and product information. The merchant can also include pictures, descriptions, sizes, colors and/or quantities, etc., of the products for sale. Generally, the products entered by the merchant will be those products to which the opportunity for a discount will apply, but other products can be included in the system 100 for regular sale to customers.

Although described as a third party user, a merchant can in fact be the owner of the system itself. In such an embodiment the merchant might not have a user account as described above. In addition, an owner/merchant might be the only merchant using the system, for example, a large retailer might utilize the system and be the only merchant using the system to offer potential discounts to its customers.

In order to determine the discounts, system computer 108 requires at least the quantity of a product to be sold, the retail price for the product to be sold and an average yield price for each product to which an opportunity for a discount is to be provided. The merchant is instructed to provide this information for each product that is to be provided an opportunity for a discount. System 108, i.e. the processor, then determines the discount(s) available for each product. The discounts that system computer 108 determines can be of any dollar amounts or percentages.

In addition to the discounts, a certain quantity of products can remain at full retail price, although in the preferred embodiment all of the products offered will be presented at an initial discounted price and opportunities for further discounts will be made available to the customer. The retail price may or may not be listed to indicate the initial savings to the customer. Once the quantity, retail price and average yield price is input by the merchant, system 108 determines prices for different numbers of the product such that the average yield price for the product is met on the sale of a quantity of product available for sale.

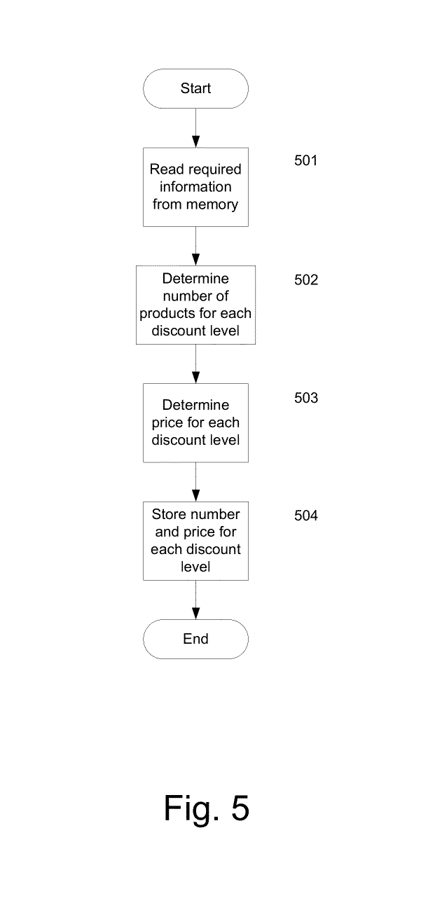

FIG. 5 illustrates the process for determining the discount prices. A merchant submits the retail price Pᵣ, the average yield price Pₐ, and the number of products for sale n. The number of products available for each discount level is determined by Equation (1):

xᵢ=cᵢn (1)

where

xᵢ is the quantity of products to be sold at price Pᵢ, the ith price,

n is the total number of products available for sale, and

cᵢ is the coefficient representing the percentage of products to be sold at price P.

One example of a distribution of products at different discount levels can be set as follows:

x₁=0.3n,x₂=0.25n,x₃=0.2n,x₄=0.15n,x₅=0.1n.

In order to control the number of products xᵢ at each discount level, coefficient cᵢ needs to be adjusted according to Equation (2):

$${\sum }_{i = 1}^{5} {c}_{i} = 1 \qquad ( 2 )$$

For example, if x₅ is to be 2% of the products, c₅=0.02, leaving a remaining 98% of the products available at other discount prices.

The average yield price Pₐ can now be determined as per Equation (3):

$${P}_{a} = \frac{{\sum }_{i = 1}^{5} {P}_{i} {x}_{i}}{n} = \frac{{\sum }_{i = 1}^{5} {P}_{a} {x}_{i}}{n} \qquad ( 3 )$$

Based on Equation (3), Pₐxᵢ can be computed directly for each of the above values of x. Pₐ is a constant.

The system generates a random number of amount and index i and j, where i≠j; and generate a relevant random number where 0<Rand( )<Pₐxᵢ.

| I | j | Amount |
|---|---|---|
| 1 | 3 | 1238 |
| 2 | 3 | 19 |
| 4 | 5 | 1546 |

where i and j are both discount levels. The amount is the number of dollars to reshuffle a and convert Pₐ into P. For example, numbers 8 and 10 have and average of 9. If 8 and 10 are to be changed while maintaining the average, the same number can be subtracted from one and added to the other. In the example set forth above, random number to subtract =5. Thus 8−5=3 and 10+5=15. The average of 3 and 15 remains at 9. IN the table above, i=1 for 8 as the discount level and j=2 for 10 as the discount level. For example, P₁ and P₃ can be computed as follows:

$${P}_{1} = \frac{{P}_{a} {x}_{1} - 1238}{{x}_{1}}$$

$${P}_{3} = \frac{{P}_{a} {x}_{3} + 1238}{{x}_{3}}$$

A new price distribution can be created by simple replacement, under the constraint:

0≦Pᵢ≦Pᵣ

In order for Pᵢ to equal Pᵣ, the difference is computed by

$$diff = Pr - {max}_{t = 1 to 5} {P}_{i} .$$

The process is repeated from Equation (3) when adding diff to the maximum Pᵢ and subtracting it from another Pᵢ.

For example, if 500 units of product A are available, at a retail price of $100.00, and the merchant wants to average $30.00 per unit, system 108 determines, as one possible scenario, the number of units and prices as shown in Table 1.

TABLE 1

| Number of units | Price per unit |
|---|---|
| 150 | $50.00 |
| 90 | $40.00 |
| 80 | $30.00 |
| 70 | $20.00 |
| 60 | $10.00 |
| 50 | FREE |

System 108 can include programming to calculate more than one or different scenarios based on the input information to arrive at the average yield price. For example, more products for FREE can be made available by modifying the price per unit or the number of products at discount. What is central to the discount determination is meeting the average yield price per product sold.

As another example, the system can divide the total quantity of items for sale into a preset number of groups, each group representing a different discount level. For each of the groups a different coefficient is selected to determine the total quantity of items for each group. For each of the groups the discounts are determined by randomly generating prices, which can vary from $0.00 (free) up to the sale price. Each group of prices contains free price.

In another embodiment, the system predetermines the discount to be provided to a customer based on the order in which a customer is provided the opportunity for the discount. The order can be determined according to an algorithm or based on an order manually entered into the system.

That is, the system can predetermine that the first customer who is provided an opportunity for a discount is to be provided a discount of 75%, the second customer who is provided an opportunity for a discount is to be provided a discount of 5%, and the nth customer who is provided an opportunity for a discount is to be provided a discount of 100%.

It is noted that as sales are being made, system 108 can update the determination of discounts if sales are slow in order to meet the merchant's average yield price for actual products sold. This update process can be undertaken at set intervals, for example, once a day for longer sales or once every 10 minutes for a short term sale (e.g. a one day sale), or set to occur after a set number of products is sold, for example, update after 25% of the items are sold. Other variations for the update process are contemplated. What is important is that system computer 108 tracks the sales, prices and discounts, and updates the discounts to meet the average yield price per product actually sold.

Typically, the opportunity for a discount is presented to the customer in the form of a game. These games can include games of chance (e.g. the roll of a dice, rock-paper-scissors, a spin of a wheel) or a game of skill (e.g. target practice or a dart game). Other opportunities are contemplated, for example, answering a trivia question, doing a math problem, etc. Whatever the opportunity, system computer 108 uses the opportunity provided to determine if a discount is to be provided and if so for how much.

The merchant can also be provided the control over which opportunity for discount is presented to customers for each product.

After system computer 108 has determined the discounts, system computer 108 makes the product(s) available to a customer via a customer interface (not shown) available on computers 104a-104c. Computers 104a-104c can be personal computers, mobile devices, etc. This customer interface can be in the form of a typical e-commerce site, for example, can include a shopping cart, various departments and categories of products, listings of specific product manufacturers, etc.; other items available on the customer interface are contemplated. In addition to the typical elements of an e-commerce site, system 100 provides on the computers 104a-104c the customer with the opportunity for the discount.

For example, customer 102a selects a product and inputs through computer 104a a request to purchase the product. System computer 108 processes the purchase via an online electronic payment system (e.g. credit card, electronic clearing house, PayPal, etc.). In one embodiment and after the purchase is completed, system computer 108 then provides to the customer the opportunity for a discount. The information in Table 1 can be displayed to the customer. The customer enters an input based on the particular opportunity presented. For example, if the opportunity is a spin of the wheel game, the customer is provided a start button and a stop button. The start button will start the wheel spinning and the stop button will stop the wheel from spinning. The wheel can have the discounts listed thereon and based on where the wheel comes to rest will determine if the customer gets a discount and for how much. Based on the discounts available and the input from the customer, system computer 108 determines if a discount is available. System computer 108 then notifies the customer if a discount is available and if so for how much. If a discount is made available to the customer, system computer 108 automatically credits the customer's account with the discount amount via the electronic payment system used to purchase the product.

In the other embodiment set forth above, prior to final purchase, system computer 108 can present and process the opportunity for a discount and apply the discount to a purchase price before electronic payment processing.

In yet a further embodiment, the system predetermines the discount to be provided to a customer based on the order in which a customer is provided the opportunity for the discount. That is, the system can predetermine that the first customer who is provided an opportunity for a discount is to be provided a discount of 75%, the second customer who is provided an opportunity for a discount is to be provided a discount of 5%, and the nth customer who is provided an opportunity for a discount is to be provided a discount of 100%.

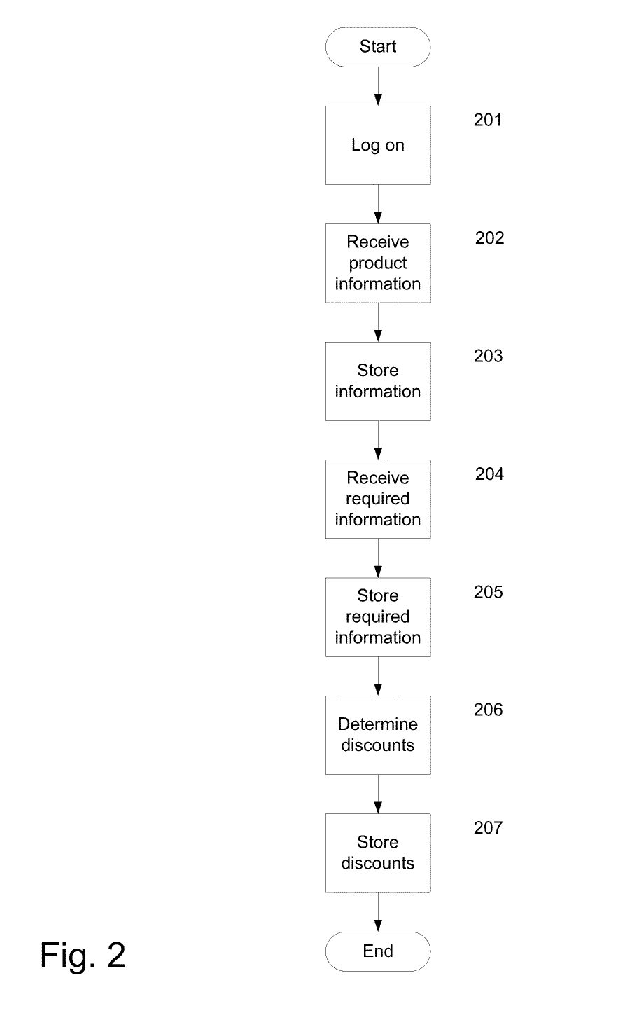

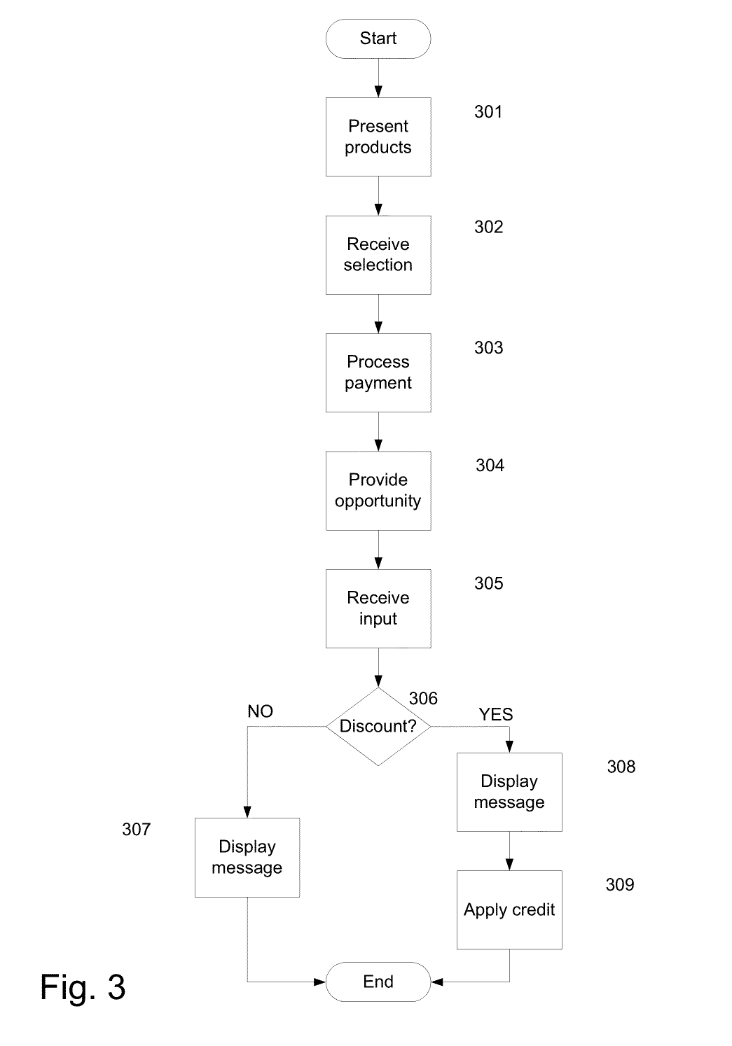

The method for providing an opportunity for a discount will now be described in more detail. System 100 operates to perform merchant processing functions and customer processing functions. FIG. 2 illustrates the method for the merchant side of the processing and FIG. 3 illustrates the customer side of the processing.

Initially, in step 201a merchant logs onto system computer 108 through merchant terminal 107. A typical account can be set up containing detailed information about the merchant. For example, company name, contact information, address, market area in which merchant deals, etc. Once logged on, in step 202 the merchant indicates products that are available for sale on the e-commerce site. This process includes entering specific details about the products for sale, which can include, but are not limited to, picture(s), description(s), size(s), color(s), quantity(s), etc. In step 203 this information is stored in memory of system computer 108. In step 204 the merchant enters a retail price for each product and an average sale price to be met for the quantity of each product. The opportunity for a discount for each product can also be selected at this step in the process. In step 205 this information is stored in memory of system computer 108.

System computer 108, i.e. the processor, in step 206 then determines the discount(s) available for each product based on the quantity, retail price and average yield price. As described above, the opportunity selected can also be used in the determination of the discounts available. In step 207 system computer 108 stores the determined discounts in the memory of system computer 108.

At this point in the process, system computer 108 has performed the functions to process the merchant side information, determine the discounts and opportunities, and awaits a customer. It is noted that different games can have different discount structures or opportunities. For example, a first game may provide 5 discount levels with the minimum discount available being 50% for 7% of the number of products for sale, while another game will provide 3 discount levels with the minimum discount available being 20% for 35% of the number of products for sale; other schemes are contemplated. The merchant can review and select the discount scheme that best suits its needs.

After system computer 108 has determined the discounts, in step 301 system computer 108 makes the product(s) available to a customer via the customer interface. In step 302 the customer selects a product and inputs a request to purchase the product. In step 303, system computer 108 processes the purchase via an online electronic payment system. In step 304, system computer 108 provides to the customer the opportunity for a discount. As noted above, the processing of the payment can be suspended until after the opportunity depending on system set-up.

In step 305, system computer 108 receives the input from the customer based on the particular opportunity presented. Based on the discounts available and the input from the customer, in step 306 system computer 108 determines if a discount is available. If no discount is available, in step 307 system computer 108 then notifies the customer that no discount is available. If a discount is available, in step 308 system computer 108 notifies the customer of the discount. If a discount is made available to the customer, in step 309 system computer 108 automatically credits the customer's account with the discount amount via the electronic payment system used to purchase the product.

In another embodiment, the system is designed to always provide at least a minimum discount to all customers that play the game. That is, the system calculates the discount levels with no products receiving a 0% discount.

In the other embodiment set forth above, prior to final purchase, system computer 108 can present and process the opportunity for a discount and apply the discount to a purchase price before electronic payment processing.

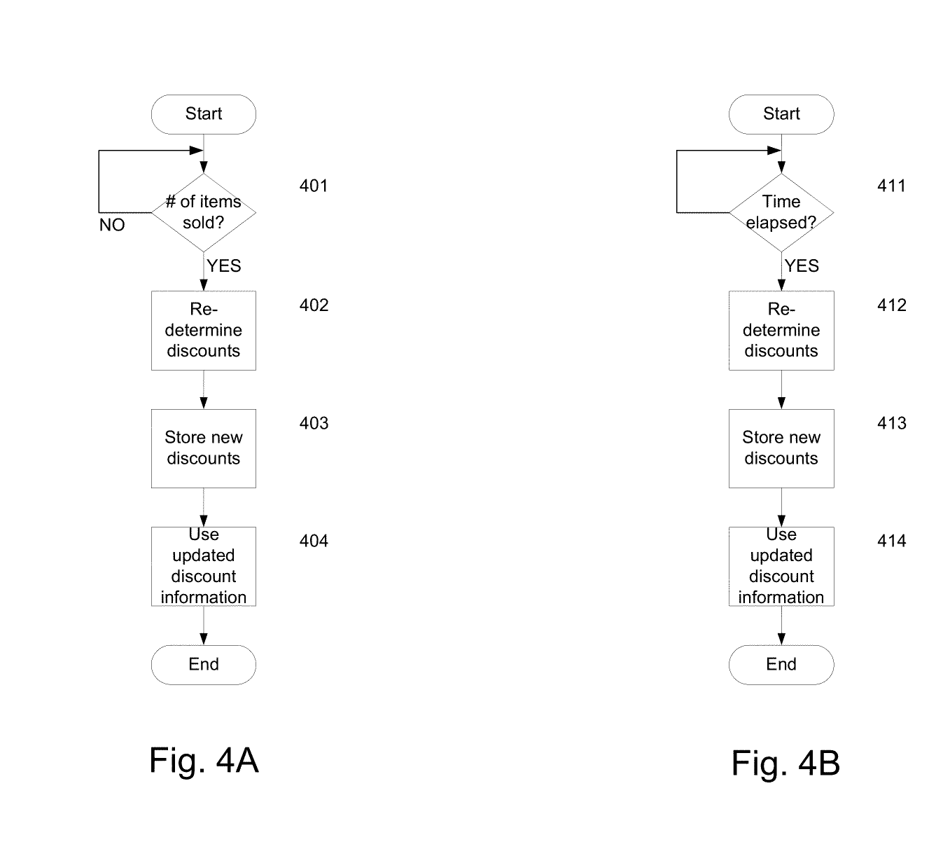

As stated above, one aspect of the present invention is to provide a system and method for providing a discount to a customer while maintaining an average yield price per product sold. FIGS. 4A and 4B are diagrams illustrating methods for providing a discount to a customer while maintaining an average yield price per product sold.

As sales are being made, system computer 108 can update the determination of discounts if sales are slow in order to meet the merchant's average yield price for actual products sold. In step 401, system computer 108 determines if a preset number of products have been sold. If not, the process returns to step 401. If so, in step 402 system computer again determines the discounts and number of products available at each discount price based on the opportunity for a discount, a remaining number of products, a number of products sold and the average yield price. In step 403 system computer 108 saves the updated information in the memory. In step 404 system computer 108 uses the updated discounts for the opportunity for a discount process.

This update process can be undertaken at set intervals of time. In step 411, system computer 108 determines if a preset time has elapsed since the sale has started. If not, the process returns to step 411. If so, in step 412 system computer again determines the discounts and number of products available at each discount price based on the opportunity for a discount, a remaining number of products, a number of products sold and the average yield price. In step 413 system computer 108 saves the updated information in the memory. In step 414 system computer 108 uses the updated discounts for the opportunity for a discount process.

It is noted that a combination of time and number of items sold can be used to trigger the re-evaluation process. Other methods of triggering the event are contemplated.

In addition, the system can predetermine the discount to be provided to a customer based on the order in which a customer is provided the opportunity for the discount. That is, the system can predetermine that the first customer who is provided an opportunity for a discount is to be provided a discount of 75%, the second customer who is provided an opportunity for a discount is to be provided a discount of 5%, and the nth customer who is provided an opportunity for a discount is to be provided a discount of 100%.

The system can also provide feedback to the customers viewing the customer page. For example, the system can alert customers to the discounts being awarded to further entice customers to use the system and play the games.

Where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

While the preferred embodiments of the devices and methods have been described in reference to the environment in which they were developed, they are merely illustrative of the principles of the inventions. Modification or combinations of the above-described assemblies, other embodiments, configurations, and methods for carrying out the invention, and variations of aspects of the invention that are obvious to those of skill in the art are intended to be within the scope of the claims.

What is claimed is:

1. A method for providing a discount to a customer, comprising:
receiving at a processor from a first terminal a request of a customer to purchase a product;
providing by the processor through the first terminal the customer with an opportunity to receive a discount on the purchase of the product from among a plurality of discounts;
receiving from the first terminal an input by the customer based on the opportunity provided;
determining by the processor to provide either a discount or no discount based on the input and at least one discount criteria for the product;
if a discount is provided, crediting the customer with the discount through an electronic payment system; and
providing at the first terminal the results of the determination.

2. The method of claim 1, further comprising:
processing by the processor the purchase of the product through the electronic payment system; and
after processing of the purchase of the product, providing the opportunity for a discount to the customer.

3. The method of claim 1, wherein the discount for the product is based in part on a quantity of the product available for sale, a retail price of the product and an average yield price for the quantity of the product.

4. The method of claim 1, wherein the opportunity is one of a game of chance and a game of skill.

5. The method of claim 1, wherein the plurality of discounts includes a plurality of discount prices and a number of product for discount at each of the plurality of discount prices.

6. The method of claim 5, further comprising:
determining by the processor the plurality of discount prices and the number of product for discount at each of the plurality of discount prices based on the opportunity for a discount, the quantity of products and the average yield price.

7. The method of claim 6, further comprising:
after a predetermined number of products are sold, re-determining by the processor the plurality of discount prices and the number of product for discount at each of the plurality of discount prices based on the opportunity for a discount, a remaining number of products, a number of products sold and the average yield price.

8. The method of claim 6, further comprising:
after a predetermined amount of time has elapsed, re-determining by the processor the plurality of discount prices and the number of product for discount at each of the plurality of discount prices based on the opportunity for a discount, a remaining number of products, a number of products sold and the average yield price.

9. The method of claim 1, wherein a discount is always provided to a customer.

10. The method of claim 1, wherein the processor predetermines a discount to be provided to a customer based on an order in which a customer is provided the opportunity.

11. A system for providing a discount to a customer, comprising:
a processor for receiving from a first terminal a request of a customer to purchase a product, providing through the first terminal the customer with an opportunity to receive a discount on the purchase of the product, receiving from the first terminal an input by the customer based on the opportunity provided, determining to provide either a discount or no discount based on the input and at least one discount criteria for the product, if a discount is provided, crediting the customer with the discount through an electronic payment system, and providing at the first terminal the results of the determination; and
a memory for storing product information to enable the processor to process the purchases and provide the opportunity.

12. The system of claim 11, wherein the discount criteria for the product is based in part on a quantity of the product available for sale, a retail price of the product and an average yield price for the quantity of the product.

13. The system of claim 11, wherein the processor processes the purchase of the product through the electronic payment system; and after processing of the purchase of the product, provides the opportunity for a discount to the customer.

14. The system of claim 11, wherein the processor predetermines a discount to be provided to a customer based on an order in which a customer is provided the opportunity.

15. A method for providing a discount to a customer, comprising:
receiving at a processor from a first terminal an identity of a product for sale, a quantity of the product available for sale, a retail price for the product, and an average yield price for the quantity of the product;
receiving at the processor a selection of a particular opportunity for a discount from a plurality of opportunities for a discount;
determining by the processor a plurality of discount prices and a number of product for discount at each of the plurality of discount prices based on the opportunity received from the merchant, the quantity of products and the average yield price;
receiving from a customer a request for a purchase of a product for processing through an electronic payment system;
providing by the processor at the second terminal the opportunity for a discount to the customer;
receiving by the processor through the second terminal an input from the customer based on the opportunity for a discount;
crediting the customer with the discount through the electronic payment system; and
providing at the second terminal the results of the determination of a discount.

16. The method of claim 15, further comprising determining by the processor to provide no discount.

17. The method of claim 15, further comprising:
processing the purchase of the product through the electronic payment system; and
after processing of the purchase of the product, providing the opportunity for a discount to the customer.

18. The method of claim 15, wherein the plurality of discounts includes a plurality of discount prices and a number of product for discount at each of the plurality of discount prices.

19. The method of claim 18, further comprising:
determining by the processor the plurality of discount prices and the number of product for discount at each of the plurality of discount prices based on the opportunity for a discount, the quantity of products and the average yield price.

20. The method of claim 19, further comprising:
after a predetermined number of products are sold, re-determining by the processor the plurality of discount prices and the number of product for discount at each of the plurality of discount prices based on the opportunity for a discount, a remaining number of products, a number of products sold and the average yield price.

21. The method of claim 19, further comprising:
after a predetermined amount of time has elapsed, re-determining by the processor the plurality of discount prices and the number of product for discount at each of the plurality of discount prices based on the opportunity for a discount, a remaining number of products, a number of products sold and the average yield price.

22. The method of claim 15, wherein the processor predetermines a discount to be provided to a customer based on an order in which a customer is provided the opportunity.

23. A system for providing a discount to a customer, comprising:
a processor for receiving from a first terminal an identity of a product for sale, a quantity of the product available for sale, a retail price for the product, and an average yield price for the quantity of the product, receiving from a merchant a selection of a particular opportunity for a discount from a plurality of opportunities for a discount, determining a plurality of discount prices and a number of product for discount at each of the plurality of discount prices based on the opportunity received from the merchant, the quantity of products and the average yield price, receiving from a second terminal a request from a customer to purchase a product, providing at the second terminal the opportunity for a discount to the customer, receiving through the second terminal an input from the customer based on the opportunity for a discount, crediting the customer with the discount through an electronic payment system, and providing at the second terminal the results of the determination of a discount; and
a memory for storing product information to enable the processor to process the purchases and provide the opportunity.

24. The system of claim 23, wherein the processor processes the purchase of the product through the electronic payment system; and after processing of the purchase of the product, provides the opportunity for a discount to the customer.

25. The system of claim 23, wherein the processor, after at least one of a predetermined number of products are sold or a predetermined time has elapsed, re-determines by the processor the plurality of discount prices and the number of product for discount at each of the plurality of discount prices based on the opportunity for a discount, a remaining number of products, a number of products sold and the average yield price.

26. The system of claim 23, wherein the processor predetermines a discount to be provided to a customer based on an order in which a customer is provided the opportunity.
